(19) United States
(12) Patent Application Publication
(10) Pub. No.: US 2026/0251767 A1
(43) Pub. Date: Aug. 27, 2026

(54) MULTI-TARGET THREE-DIMENSIONAL MEASUREMENT APPARATUS AND METHOD BASED ON DUAL-OPTICAL COMB FEMTOSECOND LIDAR

(71) Applicant: Guilin University of Technology, Guilin (CN)

(72) Inventors: Guoqing Zhou, Guilin (CN); Jiajun Zhu, Guilin (CN); Xiang Zhou, Guilin (CN)

(21) Appl. No.: 19/257,524

(22) Filed: Jul. 2, 2025

(30) Foreign Application Priority Data
Feb. 26, 2025 (CN) 202510219992.5

(51) Int. Cl. G01S 7/484; G01S 7/481; G01S 17/42

(52) U.S. Cl. CPC G01S 7/484; G01S 7/4817; G01S 17/42

(57) ABSTRACT

A multi-target three-dimensional measurement apparatus based on a dual-optical comb femtosecond lidar includes dual-optical comb laser source, single-detector time-division switching receiving module, beam-splitting and optical-switch module and scanning galvanometer module connected in sequence, and signal control processing module connected to the single-detector time-division switching receiving module. Reference pulse signal and target pulse signal are generated based on modules above, and a to-be-measured distance of a target object is determined by performing distance calculation according to the reference pulse signal and target pulse signal of each target optical path, and the target object is reconstructed in three dimensions according to the to-be-measured distance of the target object and angle information of the scanning galvanometer to generate a point cloud or 3D contour map of the target object in current scenario. Implementation difficulty and measurement error of the system can be reduced.

### CROSS-REFERENCE TO RELATED APPLICATION

This patent application claims the benefit and priority of Chinese Patent Application No. 202510219992.5 filed with the China National Intellectual Property Administration on Feb. 26, 2025, the disclosure of which is incorporated by reference herein in its entirety as part of the present application.

### TECHNICAL FIELD

The present disclosure relates to the field of femtosecond laser measurement, and in particular to a multi-target three-dimensional measurement apparatus and method based on a dual-optical comb femtosecond lidar.

### BACKGROUND

With rapid development of automation, intelligent transportation, robotics and scientific research, there is an increasing demand for high-precision, high-speed and multi-target 3D measurement and imaging technology.

Chinese Patent Application Publication No. CN102998676A has disclosed a ranging system based on a dual-comb femtosecond laser. This application provides a ranging system based on a dual-comb femtosecond laser with high precision, wide range, dead-zone-free measurement, and self-correction capability for air refractive index, but the system cannot carry out three-dimensional scanning and multi-target simultaneous ranging detection.

Chinese Utility Model Patent No. CN221465826U has disclosed a two-photon imaging method based on pulsed multi-channel time-division multiplexing for measurement through optical path lengths with different delays. However, in this method, as the signals of multiple channels are close in time, echo signal superposition or overlapping may occur, resulting in measurement errors or signal distortion. In addition, more complex signal processing algorithms are needed to distinguish and analyze echo signals with different delays, which increases a computational burden.

The paper “Dual femtosecond laser multi-target absolute distance measurement based on time-domain distinguishable features” published in Chinese Journal of Scientific Instrument has proposed a multi-target ranging scheme. According to this scheme, a femtosecond laser source can reach multiple targets at the same time by splitting beams through optical fibers. By distinguishing reference pulses from different paths through pulse intensity differences and matching them with corresponding measurement pulses, multi-channel distance measurement can be achieved. Afterwards, the real-time calculation of the multi-target absolute distance can be achieved through an strength cross-correlation module and a field programmable gate array (FPGA) data processing unit. However, such a multi-channel parallel measurement also has obvious shortcomings: on the one hand, the simultaneous transmission of multiple pulses is prone to crosstalk or partial overlap, which requires more complicated signal separation and matching algorithms, leading to the increase of the difficulty of system implementation; on the other hand, the requirements for the light source power, the optical fiber and detector configuration are higher, leading to the increase of the overall cost and volume accordingly. Moreover, in the case of a large number of targets or a far distance, the problems of signal-to-noise ratio reduction and measurement error amplification are more likely to occur.

### SUMMARY

An objective of the present disclosure is to provide a multi-target three-dimensional measurement apparatus and method based on a dual-optical comb femtosecond lidar to solve the problems of system implementation difficulty and large measurement error.

To achieve the objective above, the present disclosure provides the following technical solutions:

In a first aspect, the present disclosure provides a multi-target three-dimensional measurement apparatus based on a dual-optical comb femtosecond lidar, including a dual-optical comb laser source, a single-detector time-division switching receiving module, a beam-splitting and optical-switch module and a scanning galvanometer module connected in sequence, as well as a signal control processing module connected to the single-detector time-division switching receiving module.

The dual-optical comb laser source is configured to emit a measurement signal pulse to a reference target in the single-detector time-division switching receiving module and a target optical path in the beam-splitting and optical-switch module, and further configured to emit a sampling signal pulse to a reference optical path and a measurement optical path in the single-detector time-division switching receiving module.

The single-detector time-division switching receiving module is configured to receive an echo pulse from each target optical path according to a timing switching signal, enabling the echo pulse and the sampling signal pulse to undergo sum-frequency generation in the measurement optical path, perform photodetection by a first photodetector to generate a target pulse signal, and input the target pulse signal into Channel 1 of an analog-to-digital converter, where the echo pulse is an echo pulse of the measurement signal pulse; and further configured to enable a reflected pulse passing through the reference target and the sampling signal pulse to undergo sum-frequency generation in the reference optical path, perform photodetection by a second photodetector to generate a reference pulse signal, and input the reference pulse signal into Channel 2 of the analog-to-digital converter.

The beam-splitting and optical-switch module is configured to divide the measurement signal pulse into a plurality of pulses to be emitted to the target optical paths, and control on-off of an optical switch on each target optical path according to the timing switching signal to implement time-division multiplexing measurement on a plurality of targets or channels.

The scanning galvanometer module is configured to in each target optical path, sample a target area to be measured of a target object in a two-dimensional or three-dimensional space using a scanning galvanometer according to a predetermined scanning trajectory.

The signal control processing module is configured to perform distance calculation according to the reference pulse signal and the target pulse signal of each target optical path to determine a distance to be measured of the target object, and perform three-dimensional reconstruction on the target object according to the distance to be measured of the target object and angle information of the scanning galvanometer to generate a point cloud or three-dimensional contour map of the target object in a current scenario.

In a second aspect, the present disclosure provides a multi-target three-dimensional measurement method based on a dual-optical comb femtosecond lidar. The multi-target three-dimensional measurement method based on the dual-optical comb femtosecond lidar is applied to the multi-target three-dimensional measurement apparatus based on the dual-optical comb femtosecond lidar described above, and includes the following steps:
by a dual-optical comb laser, emitting a measurement signal pulse to a reference target in a single-detector time-division switching receiving module and a target optical path in a beam-splitting and optical-switch module, and emitting a sampling signal pulse to a reference optical path and a measurement optical path in the single-detector time-division switching receiving module;
generating a target pulse signal according to an echo pulse of the measured signal pulse returned by the target optical path and the sampling signal pulse on the measurement optical path;
generating a reference pulse signal according to a reflected pulse passing through the reference target and the sampling signal pulse;
performing distance calculation according to the reference pulse signal and the target pulse signal of each target optical path to determine a distance to be measured of a target object; and
reconstructing the target object in three dimensions according to the distance to be measured of the target object and angle information of a scanning galvanometer to generate a point cloud or three-dimensional contour map of the target object in a current scenario.

According to specific embodiments of the present disclosure, the present disclosure has the following technical effects:

According to the present disclosure, only one photodetector is provided for echo pulses of multiple target optical paths, and a time-division switching mode of a single detector is adopted to receive echo pulses of various target optical paths in sequence, so that the hardware complexity and cost are reduced. According to the present disclosure, only one echo pulse of the target optical path is received at a time, so that crosstalk or signal overlap caused by multiple echo pulses arriving at the photodetector at the same time is avoided, the measurement error is reduced, the implementation difficulty is low, the requirements on the light source power and detector sensitivity are reduced, the complexity of signal separation and matching algorithms is reduced, and the signal-to-noise ratio and accuracy of measurement are effectively improved. Based on a timing switching signal, a reflection channel to be measured can be dynamically selected to meet different measurement requirements.

In addition, the present disclosure also provides a reference optical path. Distance calculation is performed according to a reference pulse signal and a target pulse signal on each target optical path to determine a distance to be measured of a target object, the target object is reconstructed in three dimensions according to the distance to be measured of the target object and angle information of a scanning galvanometer to generate a point cloud or three-dimensional contour map of the target object in the current scenario. The present disclosure can measure the distance to be measured of the target object, as well as the point cloud or three-dimensional contour map of the target object in the current scenario.

### BRIEF DESCRIPTION OF THE DRAWINGS

To describe the technical solutions in the embodiments of the present disclosure or the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without inventive efforts.

FIG. 1 is a schematic diagram of a multi-target three-dimensional measurement apparatus based on a dual-optical comb femtosecond lidar according to the present disclosure;

FIG. 2 is a schematic diagram of a reference pulse signal optical path according to the present disclosure;

FIG. 3 is a schematic diagram of a target pulse signal optical path according to the present disclosure;

FIG. 4 is a control timing diagram according to the present disclosure;

FIG. 5 is a schematic diagram of a sampling signal pulse optical path according to the present disclosure;

FIG. 6 is a schematic diagram of a waveform that an ADC should theoretically collect at a certain moment according to the present disclosure; and

FIG. 7 is a schematic diagram of a synchronous hardware architecture according to the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art, based on the embodiments of the present disclosure, without inventive efforts shall, fall within the protection scope of the present disclosure.

To make the objectives, features and advantages of the present disclosure more clearly, the present disclosure is further described in detail below in conjunction with the accompanying drawings and with reference to the specific embodiments.

The present disclosure provides a multi-target three-dimensional measurement apparatus based on a dual-optical comb femtosecond lidar, including a dual-optical comb laser source, a single-detector time-division switching receiving module, a beam-splitting and optical-switch module and a scanning galvanometer module, which are connected in sequence, as well as a signal control processing module connected to the single-detector time-division switching receiving module.

The dual-optical comb laser source is configured to emit a measurement signal pulse to a reference target in the single-detector time-division switching receiving module and a target optical path in the beam-splitting and optical-switch module, and to emit a sampling signal pulse to a reference optical path and a measurement optical path in the single-detector time-division switching receiving module.

In practical application, the dual-optical comb laser source is composed of two femtosecond lasers, which are a local laser and a signal laser, respectively. Through a phase-locking technique, two femtosecond laser frequency combs can generate stable signals to provide high-resolution and high-speed sampling ranging ability.

The single-detector time-division switching receiving module is configured to receive an echo pulse from each target optical path according to a timing switching signal, enabling the echo pulse and the sampling signal pulse to undergo sum-frequency generation in the measurement optical path, perform photodetection by a first photodetector to generate a target pulse signal, and input the target pulse signal into Channel 1 of an analog-to-digital converter, where the echo pulse is an echo pulse of the measurement signal pulse. The single-detector time-division switching receiving module is further configured to enable a reflected pulse passing through the reference target and the sampling signal pulse to undergo sum-frequency generation in the reference optical path, perform photodetection by a second photodetector to generate a reference pulse signal, and input the reference pulse signal into channel 2 of the analog-to-digital converter.

In practical application, the single-detector time-division switching receiving module is as follows. Only two photodetectors (for reference light and multi-target light) are disposed in this present application, and a control system is configured to receive echo light of each target signal optical path in sequence according to a timing switching mode. The echo light of each optical path undergoes sum-frequency generation with local laser light through a sum-frequency crystal, such as periodically poled KTP (PPKTP), and is filtered by a low pass filter (LPF) to remove clutters and then input into the photodetector, and thus an electrical signal is output to the analog-to-digital converter (ADC).

The photodetector employs an avalanche photodiode (APD), to detect an envelope of a sum-frequency signal and output an analog signal to the ADC.

The beam-splitting and optical-switch module is configured to divide the measurement signal pulse into multiple pulses to be emitted to the target optical paths, and control on-off of an optical switch on each target optical path according to the timing switching signal to implement time-division multiplexing measurement on multiple targets or channels.

In practical application, the beam-splitting and optical-switch module is as follows. The optical pulse output by the signal laser light is distributed to multiple optical paths according to a preset ratio by a beam splitter (BS). A high-speed optical switch is disposed on each optical path, and the control system is configured to open or close each liquid crystal beam shutter according to a predetermined timing signal, thereby achieving time-division multiplexing measurement of multiple targets or multiple channels.

Further, the high-speed optical switch is a liquid crystal beam shutter (LCBS), which can be rapidly turned on or off according to a timing signal set by the control system, thereby selecting echo signals of different optical paths in sequence during different time periods.

The scanning galvanometer module is configured to, in each target optical path, sample a target area to be measured of a target object in a two-dimensional or three-dimensional space using a scanning galvanometer according to a predetermined scanning trajectory.

In practical application, the scanning galvanometer module is configured to, in each signal optical path, sample a target area to be measured point by point or line by line in the two or three-dimensional space according to the predetermined scanning trajectory, using a Galvanometers scanning galvanometer.

Further, the scanning galvanometer module is Galvanometers scanning galvanometers (Galvanometers 1, Galvanometers 2) and driver circuit thereof, to change a beam exit angle to scan and measure the target object in the three-dimensional space range.

The signal control processing module is configured to perform distance calculation according to the reference pulse signal and the target pulse signal of each target optical path to determine a distance to be measured of the target object, and perform three-dimensional reconstruction on the target object according to the distance to be measured of the target object and angle information of the scanning galvanometer to generate a point cloud or three-dimensional contour map of the target object in a current scenario.

In practical application, the signal control processing module is configured to receive a digitized signal output from the analog-to-digital converter (ADC), and perform distance calculation and three-dimensional data reconstruction using hardware acceleration means such as FPGA+GPU, combine the angle information of the scanning galvanometer with a ranging result, convert measured internal coordinates into real three-dimensional space coordinates by a geometric calibration algorithm to generate a point cloud or three-dimensional contour map of a target scenario.

Further, the field programmable gate array (FPGA) is configured to preprocess high-speed sampled data in real time and execute initial operation of partial distance calculation.

The graphics processing unit (GPU) is configured to perform deep computing, real-time imaging and visualization processing on mass data to achieve three-dimensional reconstruction.

Through the above structures, the multi-target three-dimensional measurement is achieved, and due to the use of a time-division switching mode of a single detector, the hardware complexity and an algorithm interference risk are reduced, and the measured signal-to-noise ratio and the measurement accuracy are improved.

In an exemplary embodiment, the single-detector time-division switching receiving module specifically includes a measurement signal pulse optical path, and a sampling signal pulse optical path.

The measurement signal pulse optical path includes a reference target optical path and the reference optical path, and the reference target optical path includes a first collimator, a first half-wave plate, a first mirror, a first polarizing beam splitter, a quarter-wave plate and a reference target in the same optical path.

The measurement signal pulse is reflected into the reference optical path via the reference target optical path to undergo sum-frequency generation with the sampling signal pulse in the reference optical path, and photodetection is performed by the second photodetector to generate the reference pulse signal.

The sampling signal pulse optical path includes a reflection optical path and a polarization optical path, both which share a second collimator, a second half-wave plate and a second polarizing beam splitter. The reflection optical path further includes a second mirror and the measurement optical path; the polarization optical path further includes a third half-wave plate, a third polarizing beam splitter and the reference optical path.

After the sampling signal pulse is polarized and split by the second polarizing beam splitter, a beam of the sampling signal pulse is reflected by the second mirror to the measurement optical path, and another beam of the sampling signal pulse enters the reference optical path after passing through the third half-wave plate and the third polarizing beam splitter.

In an exemplary embodiment, the measurement optical path specifically includes a first focusing lens, a first sum-frequency crystal, a first low pass filter and the first photodetector in the same optical path.

The reference optical path specifically includes the second polarizing beam splitter, a second focusing lens, a second sum-frequency crystal, a second low pass filter, and the second photodetector in the same optical path.

In an exemplary embodiment, the beam-splitting and optical-switch module specifically includes a beam splitter, and multiple target optical paths.

The beam splitter is configured to divide the measurement signal pulse into multiple pulses to be emitted to target optical paths.

The target optical path includes an optical fiber, a third collimator, an optical switch and the target object in the same optical path, and the optical switch is a liquid crystal beam shutter.

In an exemplary embodiment, the scanning galvanometer module is arranged between the optical switch and the target object, and configured to change a beam exit angle to scan and measure the target object.

In an exemplary embodiment, the signal control processing module specifically includes an FPGA, and a GPU.

The FPGA is configured to perform distance calculation according to the reference pulse signal and the target pulse signal of each target optical path; and
the GPU is configured to perform distance calculation according to the reference pulse signal and the target pulse signal of each target optical path.

The present disclosure adopts a target signal-end single detector structure combining time division multiplexing and high-speed optical switch, and sequentially selects multiple target optical paths for ranging, thereby avoiding crosstalk or signal overlap caused by multiple pulses arriving at the detector at the same time, reducing requirements for the light source power and detector sensitivity, reducing the complexity of signal separation and matching algorithms, and effectively improving the measured signal-to-noise ratio and measurement accuracy.

The technical solution of the present disclosure is further set forth below with reference to specific examples.

In this embodiment, the dual-optical comb laser is composed of two femtosecond lasers, which are a local laser and a signal laser, respectively. Through a phase-locking technique (locking repetition frequency, carrier envelope phase, etc.), the two combs can generate a stable sum-frequency signal after sum-frequency to provide high-resolution (micron to submillimeter level) and high-speed sampling ranging ability. The signal light is distributed to different optical paths through a beam splitter (50:50 BS), and each optical path is provided with a high-speed optical switch, i.e., a liquid crystal beam shutter (LCBS1, LCBS2). The control system is configured to control an on-off state according to the predetermined timing signal to achieve time-division multiplexing.

The scanning galvanometer module is installed in a signal comb path and is provided with Galvanometers scanning galvanometers (Galvanometers 1, Galvanometers 2). The scanning galvanometer is configured to scan a signal beam in a two-dimensional or three-dimensional space according to a predetermined trajectory to achieve point-by-point or line-by-line sampling, which is suitable for measuring a large-area or multi-target scenario. A driving control board of the scanning galvanometer is configured to send real-time scanning angle information to the FPGA for subsequent geometric calibration.

The measurement principle is as follows:

A first femtosecond laser frequency comb (i.e., signal laser) and a second femtosecond laser frequency comb (i.e., local laser) are implemented by locking a repetition frequency and a phase offset frequency of an existing commercial optical fiber femtosecond laser to a rubidium atomic clock, respectively, of both which the repetition frequencies are 100 MHz and 100.003 MHz, that is, 3k measurements can be made per second. The ADC is a 14-bit model of ad9643 with 250 MHz, the scanning galvanometer model is GVS212(/M), the APD model is ky-aprm-50M-S-1MM, the low pass filter is 40 MHz, and the liquid crystal beam shutter model is LCC1623(/M). The accuracy of three-dimensional measurement is in micrometer level.

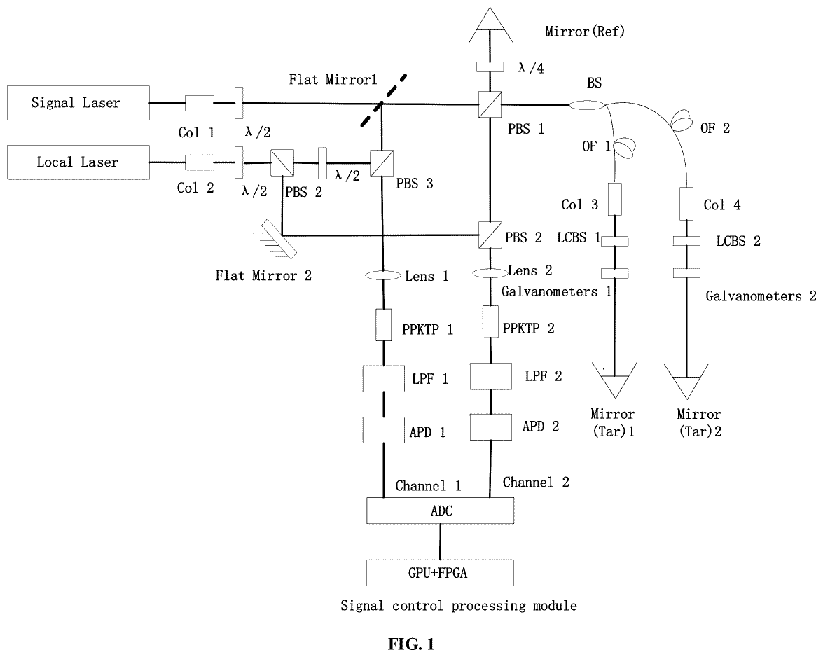

As shown in FIG. 1, the multi-target three-dimensional measurement apparatus based on the dual-optical comb femtosecond lidar provided by the present disclosure includes the first femtosecond laser frequency comb signal Laser, the second femtosecond laser frequency comb Local Laser, polarizing beam splitters PBS 1-3, a half-wave plate λ/2, a first photodetector APD 1, a second photodetector APD 2, an analog-to-digital converter ADC, and a signal control processing module; focusing lenses Len 1-2, sum-frequency crystals PPKTP 1-2, mirrors Flat Mirror 1-2, collimators Col 1-4, optical fibers OF 1-2, a beam splitter BS, target objects Mirror(Tar) 1-2, a reference target Mirror(Ref), liquid crystal beam shutters LCBS 1-2, and scanning galvanometers Galvanometers 1-2, where, is a wavelength.

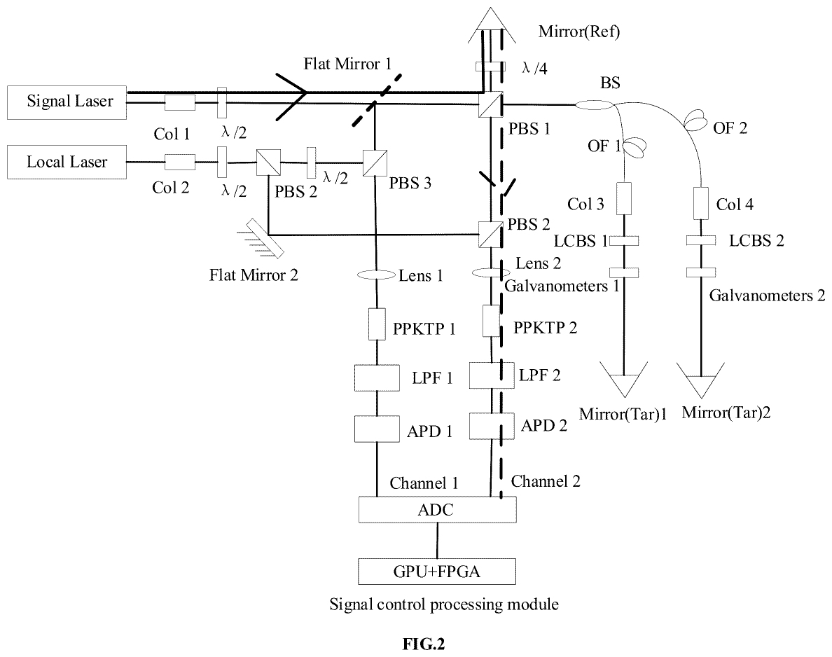

As shown in FIG. 2, an echo pulse returned by laser light of the signal laser irridating the reference target has a sum-frequency effect with local laser light, and enters APD 2, which is called the reference pulse signal. The first femtosecond laser frequency comb signal Laser is used as a measurement signal source to send out measurement signal light pulse to Col 1 for collimation, and this collimated measurement signal light pulse passes through the half-wave plate λ/2 for adjusting a polarization direction of the incident light to control a distribution ratio of light in PB. The pulse reflected by the target object on the mirror Flat Mirror1 changes in a vertical height compared with the incident pulse, and the mirror is lower in height than the incident light. At this time, the light passing through PBS1 is divided into reflected light and transmitted light, the reflected light passes through a λ/4 wave plate, and the linearly polarized light is converted into circularly polarized light to be emitted to mirror, and when the circularly polarized light is reflected on the mirror, its rotation direction will be reversed (left-rotated to right-rotated, right-rotated to left-rotated), but the circularly polarized light remains unchanged. The reflected circularly polarized light, when passing through the λ/4 wave plate again, will be converted back to the linearly polarized light.

Because the rotation direction of the circularly polarized light has been reversed, a direction of the emergent linearly polarized light has rotated by 90° relative to the initial incident light, and the linearly polarized light changes from original reflection to transmission when passing through PBS, and then passes through PBS2 to be transmitted through PBS2 and focused on PPKTP2 through Lens2. The reflected pulse of the reference target undergoes sum-frequency generation with the local laser light to generate a sum-frequency signal, which passes through LPF2 to filter out high-frequency clutters to obtain an envelope of the sum-frequency signal, passes through APD2 for photodetection, and then enters Channel 2 of ADC. The local laser light is the sampling signal pulse.

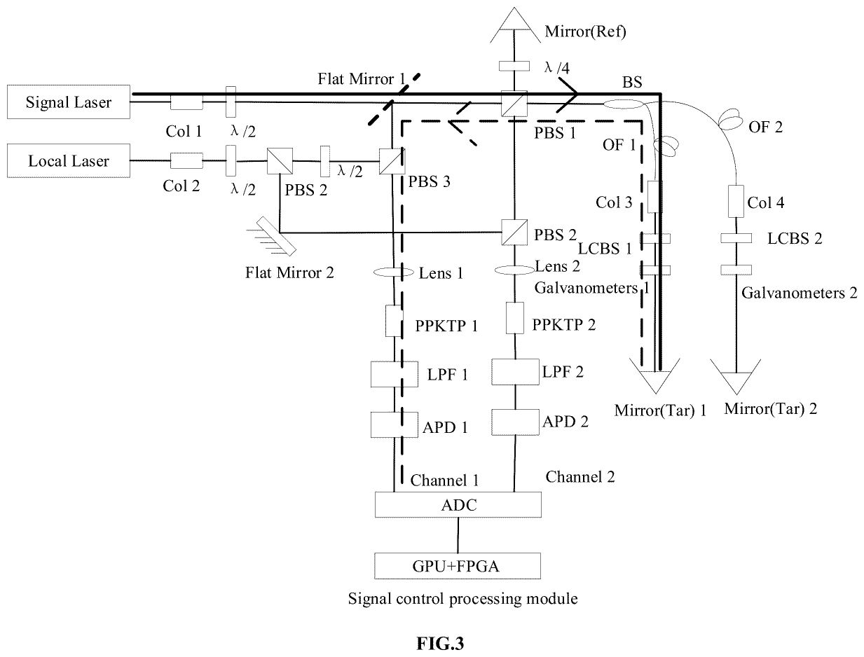

As shown in FIG. 3, an echo pulse returned by the laser light of the signal laser irradiating the target object has a sum-frequency effect with the local laser light, and enters APD 1, which is called the target pulse signal. The transmitted light passing through PBS1 passes through BS and is split at 50:50, half of which passes through OF1, is collimated by Col3, passes through the high-speed optical switch (i.e., the liquid crystal beam shutter LCBS1), and passes through the scanning galvanometer Galvanometers1 to scan at a certain frequency. Then, after passing through the target object Mirror(Tar)1, the light returns by a same way. At this time, an on-off state of the high-speed optical switch (i.e., the liquid crystal beam shutter LCBS1) is controlled by the control system according to the predetermined timing signal. In the ON state, the light is allowed to pass through and return, and the returned echo pulse is transmitted in PBS1, and then reflected by the mirror Flat Mirror1. Compared with the incident pulse, the pulse reflected by the target object on the mirror Flat Mirror1 changes in a vertical height, and the mirror is lower in height than the incident light. Through PBS3, the reflected pulse is continuously transmitted to enter Lens 1 and focused on PPKTP 1 to generate the sum-frequency effect to undergo sum-frequency generation with the local laser light to generate a sum-frequency signal, which passes through LPF1 to filter out high-frequency clutters to obtain an envelope of the sum-frequency signal, passes through APD1 for photodetection, and then enters Channel 1 of the ADC. After 50:50 splitting is carried out by BS, the other half of light passing through the OF2 enters the Channel 1 of the ADC in the same way. Further, the beam splitter (BS) is a 50:50 beam splitter, or has a beam splitting ratio that can be adjusted according to a measurement requirement. By adjusting the beam splitting ratio and the timing control of the optical switch, the number of optical paths can be flexibly increased or decreased to meet the requirements of different fields of view, different resolutions, or different measurement rates.

After the FPGA sends out an enable signal, LCBS1 is turned on, and LCBS2 is turned off to perform distance calculation on a target 1. At this time, a scanning action is performed by Galvanometers 2 for subsequent positioning or pre-scanning of a target 2, while the scanning galvanometer (Galvanometers 1) of the target 1 remains stable to reduce interference. After continuously measuring the target 1 for 600 times and solving an average value, it is switched to turn on LCBS2 and turn off LCBS1 to start the distance measurement of the target 2. At this time, Galvanometers 1 is configured to perform a scanning action to acquire an average value of 600 measurements of the target 2 in the same way. By alternately enabling different light valves and making the corresponding scanning galvanometers “remain stationary” or “act in advance”, the same target can be prevented from being disturbed by the galvanometer motion in the ranging process, thereby improving the measurement accuracy and efficiency.

In this embodiment, the target 1 is Mirror (Tar) 1, and the target 2 is Mirror (Tar) 2.

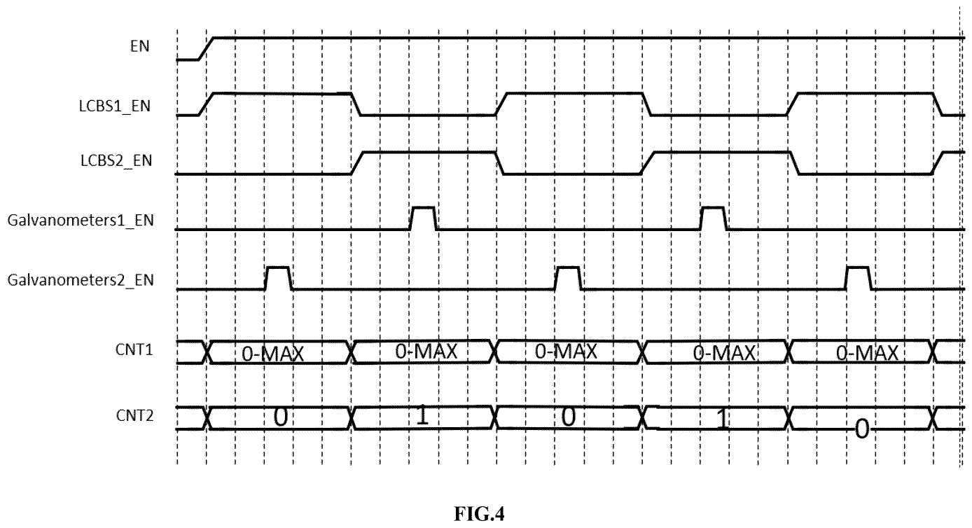

A timing diagram is shown in FIG. 4. After the system sends out an enable signal (EN), a timer CNT1 starts counting, the timer count is cleared every 0.2 seconds, and a counter CNT2 is triggered to flip between 0 and 1. When CNT2 is 0, LCBS1_EN is pulled high, and LCBS2_EN maintains at a low level. When CNT2 is 1, LCBS2_EN is pulled high, while LCBS1_EN is set low.

When LCBS1_EN is at a high level, half of its duration will pull Galvanometers2_EN higher by one clock cycle. When LCBS2_EN is pulled high, half of its duration also pulls Galvanometers1_EN higher by one clock cycle. The term “pull high” herein refers to switching the signal from a low level to a high level, which means enabling a corresponding light valve or scanning galvanometer. Through such alternating timing control and counting flipping, the time-division measurement of two targets and the cooperation of the corresponding galvanometer actions are achieve, thereby avoiding the interference with the galvanometer movement in the ranging process.

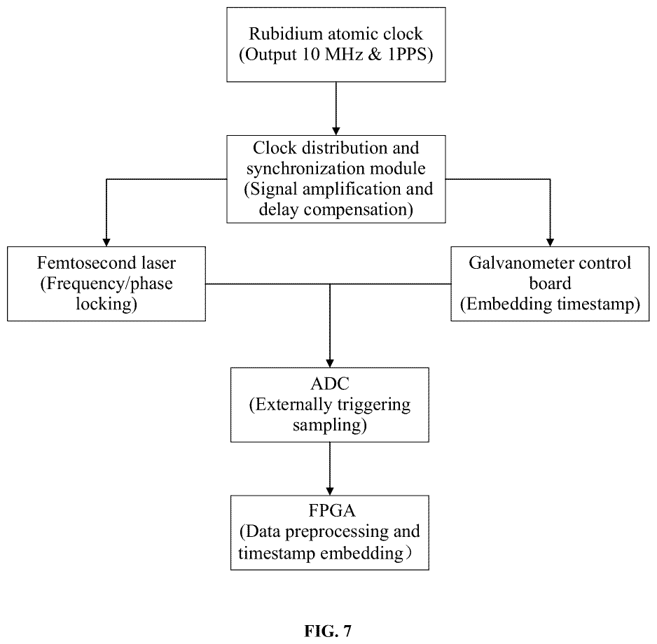

To ensure that various modules (femtosecond laser, galvanometer control board, ADC, FPGA) are in strict synchronization, a rubidium atomic clock is used as a global clock reference, and a synchronous hardware architecture is shown in FIG. 7.

The rubidium clock usually outputs two types of high-stability signals:

10 MIz reference frequency signal, configured to provide high-stability reference for frequency locking to each module; and

1 PPS (Pulse Per Second) pulse signal, configured to be as a global time stamp to provide accurate time reference for data acquisition and correction.

These signals are amplified and distributed evenly by a special clock distribution and synchronization module to each acquisition and control unit to ensure that all modules can work based on a unified time reference.

### 1. Synchronization of Femtosecond Lasers

Femtosecond lasers (including a signal laser and a local laser) perform frequency and phase locking by using the 10 MHz signal output by the rubidium clock to ensure the stability and repeatability of the output laser pulses. Meanwhile, the femtosecond laser also internally receives 1 PPS pulse as a time stamp to ensure consistency with other modules of the system in a time domain.

### 2. Synchronization of Galvanometer Control Board and Other Acquisition Modules

The galvanometer control board, ADC and FPGA all receive 10 MHz and 1 PPS signals from the clock distribution module. A high-precision counter (driven by a rubidium clock signal) is used in each module to generate a local time reference, and a time stamp is embedded in the data acquisition process based on the local time reference.

### 3. Collaborative Timestamp Embedding of ADC and FPGA

An ADC module is configured to perform data sampling under the driving of an external synchronous signal. Although the ADC does not generate a timestamp directly by itself, a sampling operation thereof is strictly triggered by a rubidium clock synchronous signal. After receiving the ADC sampled data, the FPGA in the system is configured to append current sampling time, as a timestamp, into data using a high-precision counter synchronized by the rubidium clock. In this way, all the sampled data obtained by the ADC have accurate time information, which can provide reliable time alignment basis for subsequent distance calculation and 3D reconstruction.

### 4. Signal Distribution and Delay Correction

The clock distribution and synchronization module is responsible for the uniform distribution of 10 MHz and 1 PPS signals of the rubidium clock, and some delay and jitter will be caused during transmission due to cable length, buffer circuit and the like. To solve this problem, this module is internally designed with a buffer and delay compensation circuit, which can reduce inconsistency of these transmission delays. According to pre-measured transmission delay parameters, each module can perform delay compensation on the collected data by using a real-time correction algorithm, thereby enabling time alignment accuracy of the whole system to reach microsecond level or even close to nanosecond level.

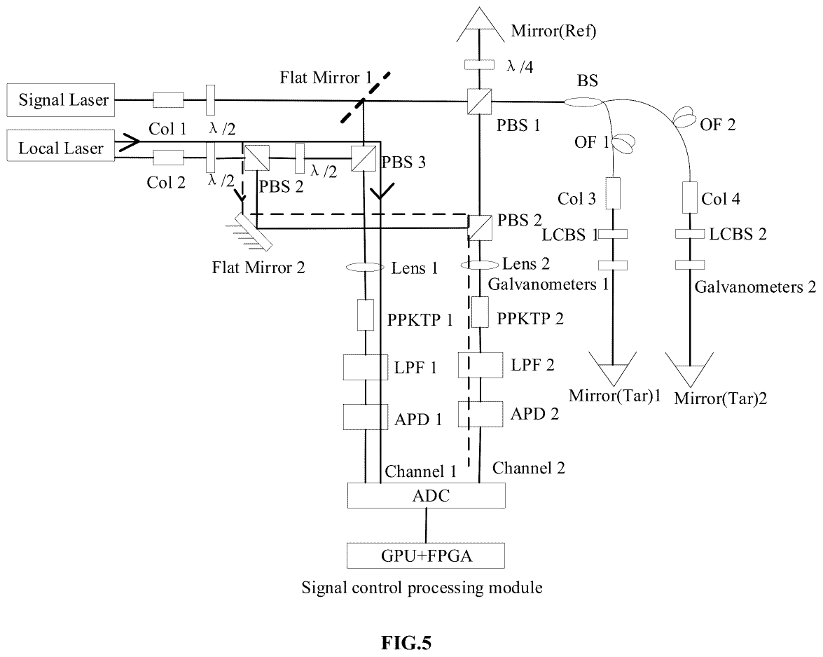

As shown in FIG. 5, the second femtosecond laser frequency comb Local Laser, as a sampling signal source, sends a light pulse to Col1 for collimation, the collimated light pulse passes through the half-wave plate for adjusting a polarization direction of the incident light to control a distribution ratio of light in PBS, and then the adjusted incident light passes through PBS2 where reflection and transmission occur. The transmitted light passes through λ/2 wave plate, is reflected by PBS3, enters Lens1 and then enters PPKT1. The echo pulse undergoes sum-frequency generation with the local laser light to generate a sum-frequency signal, which passes through LPF1 to filter out high-frequency clutters to obtain an envelope of the sum-frequency signal, passes through APD1 for photodetection, and then enters Channel 1 of the ADC. The reflected light is reflected by the mirror Flat Mirror2, enters PBS2 to be reflected into Lens2, and then undergoes sum-frequency generation with the signal laser to generate a sum-frequency signal. The sum-frequency signal passes through LPF2 to filter out high-frequency clutters to obtain an envelope of the sum-frequency signal, then passes through APD2 for photodetection, and then enters Channel 2 of the ADC.

The collected data is input by the ADC into a signal processing control unit for distance calculation.

The signal processing control unit is configured to perform distance calculation by using a GPU+FPGA two-stage data acceleration processing mode. FPGA is configured to preprocess the high-speed sampled data in real time and execute initial operation of partial distance calculation. GPU is used for deep calculation, real-time imaging and visualization processing of massive data to achieve high-frame-rate 3D reconstruction.

According to the present disclosure, after acquiring multi-target time-division echo data, a filtering and fitting method based on time-division multiplexing and Levenberg-Marquardt(LM) least-squares fitting is introduced to improve the echo peak detection accuracy and the three-dimensional measurement stability.

An embodiment of the present disclosure provides a multi-target three-dimensional measurement method based on a dual-optical comb femtosecond lidar, which is executed by a computer device, and specifically, separately executed by a terminal, a server or other computer devices, or jointly executed by the terminal and the server. In the embodiment of the present disclosure, the method includes the following steps S1-S5.

S1: By a dual-optical comb laser, a measurement signal pulse is emitted to a reference target in a single-detector time-division switching receiving module and a target optical path in a beam-splitting and optical-switch module, and a sampling signal pulse is emitted to a reference optical path and a measurement optical path in the single-detector time-division switching receiving module.

S2: A target pulse signal is generated according to an echo pulse of the measured signal pulse returned by the target optical path and the sampling signal pulse on the measurement optical path.

S3: A reference pulse signal is generated according to a reflected pulse passing through the reference target and the sampling signal pulse.

S4: Distance calculation is performed according to the reference pulse signal and the target pulse signal of each target optical path to determine a distance to be measured of a target object.

S5: The target object is reconstructed in three dimensions according to the distance to be measured of the target object and angle information of a scanning galvanometer to generate a point cloud or three-dimensional contour map of the target object in a current scenario.

In an exemplary embodiment, S4 may be replaced with the following steps including:
generating continuous sampled data by combining the reference pulse signal and the target pulse signal;
dividing the continuous sampled data into time domain segments of multiple channels based on a timing switching signal;
preprocessing each time domain segment to determine an initial position of a pulse peak.
selecting a Gaussian pulse model for an echo pulse of each channel to establish a least-squares residual function; and
using the initial position of the pulse peak as an initial fitting value based on the least-squares residual function, and fitting the Gaussian pulse model and the continuous sampled data by an LM fitting algorithm to determine the distance to be measured of the target object.

In an exemplary embodiment, using the initial position of the pulse peak as the initial fitting value based on the least-squares residual function, and fitting the Gaussian pulse model and the continuous sampled data by the LM fitting algorithm to determine the distance to be measured of the target object specifically include:
determining the distance to be measured of the target object by

$$L = \frac{c}{2 {n}_{g}} \cdot \frac{1}{{f}_{r}} \cdot \frac{{t}_{tar} - {t}_{ref 1}}{{t}_{ref 2} - {t}_{ref 1}} ,$$

where L is the distance to be measured of the target object, cis a vacuum light speed, n_{g} is an air refractive index, f_{τ} is a repetition frequency of signal laser light, tₜₓ is a target pulse peak moment of the target pulse signal, t_{ref1} a reference pulse peak moment of the reference pulse signal, and t_{ref2} is a reference pulse peak moment of the reference pulse signal in a next cycle.

In an exemplary embodiment, S5 may be replaced with the following steps including:
establishing a corresponding relationship between the distance to be measured of the target object as well as the angle information of the scanning galvanometer and real space coordinates through geometric calibration; and
reconstructing the target object in three dimensions according to the corresponding relationship to generate the point cloud or three-dimensional contour map of the target object in the current scenario.

In practical application, the geometric calibration is implemented through the following steps:

(1) A reference target or corner reflector is placed at a position where precise coordinates are known.

Further, at least 5-10 calibration points should be selected in a measured area, and the calibration points are required to be evenly distributed at edges, center and corners of the area to ensure the coverage of the whole measured area.

A high-accuracy measurement instrument is used to predetermine the real coordinates of each calibration point.

(2) A conventional measurement process of this system is executed for each reference point to obtain internal coordinates of the system.

Further, the present disclosure further includes information such as the scanning galvanometer angle, distance and so on.

The measurement process of the system is used to repeatedly measure each reference point (for example, taking an average value of 600 measurements), and distance data R obtained by laser ranging and angle information θ collected by the scanning galvanometer are collected, thereby forming the internal coordinate data.

(3) An error model is established, and the parameters such as a scanning angle and ranging are nonlinearly fitted and corrected:

$${x}_{m} = R cos ( θ )$$

$${y}_{m} = R sin ( θ )$$

where θ represents the angle information collected by the scanning galvanometer, and R is the distance information obtained by laser ranging.

The internal coordinates measured by the system are set as (xₘ, yₘ, zₘ), the real coordinates are (xₜ, yₜ, zₜ), and then the model can be expressed as follows:

$${x}_{t} = {k}_{x} \cdot ( {x}_{m} + Δ x ) + {f}_{x} ( {x}_{m} , {y}_{m} , {z}_{m} )$$

$${y}_{t} = {k}_{y} \cdot ( {y}_{m} + Δ y ) + {f}_{y} ( {x}_{m} , {y}_{m} , {z}_{m} )$$

$${z}_{t} = {k}_{z} \cdot ( {z}_{m} + Δ z ) + {f}_{z} ( {x}_{m} , {y}_{m} , {z}_{m} )$$

where kₓ, k_{y}, k_{z} are scanning scale factors of various axes (which reflects a conversion ratio from internal measurement data (including angle information) to the real coordinates), respectively; Δx, Δy and Δz are zero-point drift compensations of various axes, respectively; and fₓ, f_{y}, f_{z} are functions describing a nonlinear error, which are expressed by a quadratic or higher polynomial

$$( e . g . , {f}_{x} ( {x}_{m} , {y}_{m} , {z}_{m} ) = {a}_{1} {x}_{m}^{2} + {a}_{2} {x}_{m} {y}_{m} + {a}_{3} {y}_{m}^{2} ) .$$

(4) A mapping relationship between the angle of the scanning galvanometer and the real spatial coordinates, and correction parameters such as zero-point drift and scale factors are acquired.

Further, preliminary measurement data is used for acquiring initial values of each scale factor and zero-point drift by simple linear regression.

For example, X-axis data is regressed as: xₜ≈kₓ·xₘ+bₓ.

bₓ can be regarded as an initial estimation of Δx. Y axis and Z axis are processed in a similar manner.

A Levenberg-Marquardt (LM) algorithm is used to perform nonlinear least-squares fitting on all calibration point data to solve unknown correction parameters in the above error model.

A residual for each calibration point i is defined as follows:

$${r}_{i} = \sqrt{{( {x}_{t , i} - {\hat{x}}_{t , i} )}^{2} + {( {y}_{t , i} - {\hat{y}}_{t , i} )}^{2} + {( {z}_{t , i} - {\hat{z}}_{t , i} )}^{2}} ;$$

where
rᵢ: the “residual” of the i^{-th} calibration point;
x_{i,j}: the “real coordinates” of the i^{-th} calibration point;
\hat{x}_{i,j}: “model prediction coordinates” of the i^{-th} calibration point;
   i: a serial number of the calibration point.

The target is to minimize a sum of residual squares:

$$min {\sum }_{i = 1}^{N} {r}_{i}^{2} .$$

The parameters are iteratively updated until the residual converges or the preset number of iterations is performed, thereby obtaining an optimal correction parameter set

$$\{ {k}_{x} , {k}_{y} , {k}_{z} , Δ x , Δ y , Δ z , {a}_{1} , {a}_{2} , … \} .$$

(5) The correction parameters are firmed into system software to ensure the three-dimensional measurement accuracy of unknown targets.

In practical application, after acquiring the multi-target time-division echo data, a filtering and fitting method based on time-division multiplexing and Levenberg-Marquardt (LM) least-squares fitting is introduced to improve the echo peak detection accuracy and the three-dimensional measurement stability according to the following steps.

Step one: Time domain slicing and data rearrangement: According to timing information of a high-speed optical switch (LCBS), continuous sampled data output by an analog-to-digital converter (ADC) is divided into independent time domain segments of multiple channels. If a target channel is not enabled or has no significant echo, the corresponding data is directly discarded; a protection interval is reserved near a switching boundary of the optical switch to prevent switching from disturbing the samples.

### 1.1: Timing Marking

In FPGA, an on/off control signal of the high-speed optical switch (LCBS) is read in real time, and the timing information is mapped to a sampling clock index of ADC.

For example, if the LCBS connects to “target 1” within a time period of t=0-0.2 seconds, an N1_begin-N1_end interval of the corresponding ADC sample is a data range of echo of the target 1.

### 1.2: Data Slicing

The continuous sampled data D(k) output by ADC is divided into multiple segments Dᵢ(k) according to the above selected target timing range, where i represents a target number.

If a target channel is not enabled or has no significant echo, the corresponding data segment is directly discarded during slicing to save processing resources.

### 1.3: Protection Interval

Interference will be caused at the moment of switching of the optical switch. To avoid the influence of such an interference on the subsequent fitting, multiple sampling points (for example, 10-50 sampling points) are reserved near the switching boundary of the target channel without participating in the subsequent fitting operation.

Step two: Filtering and preprocessing: Each time domain segment is subjected to wavelet denoising and baseline correction. In a denoising result, a moving average is applied to maintain the continuity of the pulse envelope, and an initial position of a pulse peak is obtained by threshold detection.

### 2.1. Wavelet Denoising

Discrete wavelet decomposition (e.g., Daubechies order 4, decomposed into 5 layers) is performed on each sliced channel data Dᵢ(k). A coefficient with a small threshold attenuation amplitude is set in a high frequency sub-band, and then the inverse transformation is performed to remove high-frequency random noise. A reconstructed time domain signal is recorded as D̅ᵢ(k) and its high-frequency spike or random noise strength is significantly reduced.

### 2.2. Baseline Correction and Simple Smoothing

Baseline estimation is introduced into D̅ᵢ(k): an average of echo-free intervals before and after the signal is taken as a baseline value, and the baseline value is subtracted as a whole; and the remaining signal can be subjected to moving average again to ensure an overall smoothness of the pulse envelope.

### 2.3. Threshold Detection and Coarse Peak Positioning

A threshold (such as 20% of a global maximum) is set on the filtering result D̅ᵢ(k) to detect an approximate interval of the pulse peak value. The points in the threshold interval are quickly fitted by a quadratic polynomial to obtain a preliminary “peak position”

$${τ}_{i}^{( 0 )} ,$$

an “amplitude”

$${A}_{i}^{( 0 )}$$

and a “pulse width”

$${σ}_{i}^{( 0 )}$$

as initial values of subsequent LM iteration.

Step three: LM fitting model establishment: a Gaussian pulse model is selected for an echo pulse of each channel to establish a least-squares residual function.

### 3.1. Pulse Model

For a single echo pulse, the following shape model function

$${y}_{i} ( t ; {θ}_{i} ) = {A}_{i} exp [ - \frac{{( t - {τ}_{i} )}^{2}}{2 {σ}_{i}^{2}} ] + {y}_{0}$$

can be selected, where θᵢ={τᵢ, Δᵢ, σᵢ, y₀}; yᵢ(t;θᵢ) is an expression of mathematical formula. The expression represents a function yi about time t and a parameter θᵢ, yᵢ represents an i^{-th} observed value, θᵢ represents a model parameter, and t represents a model time parameter.

τᵢ is a peak position, Aᵢ is an amplitude, σᵢ is a pulse width, y₀ is an offset, since the sampled pulse generally has a non-zero direct current bias.

Due to the Gaussian function model herein,

$${A}_{i}^{( 0 )}$$

represents an initial value calculation implemented in FPGA, and Aᵢ is an amplitude of echo fitting of the i-h channel solved by the LM algorithm in GPU.

Data slicing, wavelet transform and threshold detection are implemented in FPGA. The initial values

$$\{ {τ}_{i}^{( 0 )} , {A}_{i}^{( 0 )} , {σ}_{i}^{( 0 )} , {y}_{0 i}^{( 0 )} \}$$

are uploaded to GPU, and the GPU then performs matrix operation of LM iteration.

### 3.2. Residual Function

The measured data after filtering is recorded as D̅ᵢ(k) and corresponding sampling time is tₖ; the residual is defined as r_{i,k}(θᵢ)=D̅ᵢ(k)−yᵢ(tₖ;θᵢ) and the residual squares sum

$${F}_{i} ( {θ}_{i} ) = {\sum }_{k} {[ {r}_{i , k} ( {θ}_{i} ) ]}^{2}$$

is a least-squares fitting objective function, which is used for fitting the echo of the i^{-th} channel.

Step four: LM iterative solution: the preliminary peak positioning result is used as an initial fitting value, and the pulse model and sampled data needed for fitting are input to the LM algorithm.

Collaboration of FPGA+GPU is used to achieve data slicing, wavelet transform and threshold detection in FPGA. The initial values

$$\{ {τ}_{i}^{( 0 )} , {A}_{i}^{( 0 )} , {σ}_{i}^{( 0 )} , {y}_{0 i}^{( 0 )} \}$$

are uploaded to GPU, and then GPU performs matrix operation of LM iteration, which can quickly process multi-channel data in parallel. The GPU is used for deep calculation, real-time imaging and visualization processing of massive data to achieve high-frame-rate 3D reconstruction.

Step five: Multi-frame averaging and distance calculation: multiple groups of echo data are collected by repeatedly sampling the same target, and finally, distance results obtained from multiple measurements per channel are weighted and averaged to eliminate accidental noise and acquire a more stable target distance value, and the high-precision three-dimensional reconstruction of multiple targets is achieved by combining the galvanometer angle.

### 5.1. Multi-Frame Measurement and Outlier Removing

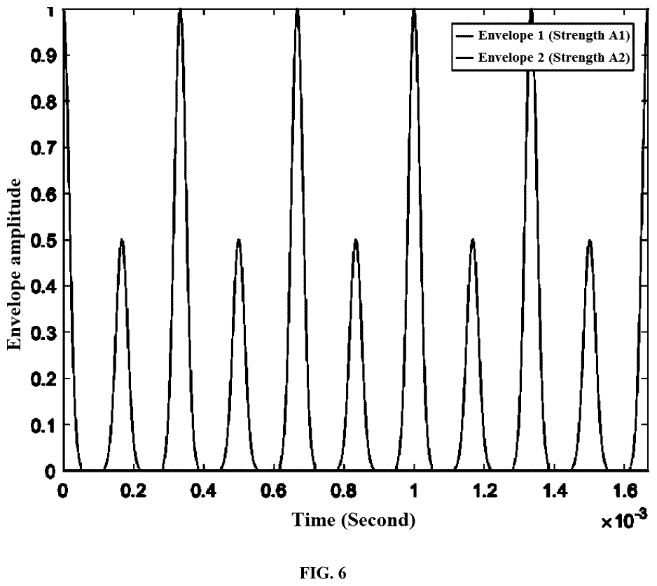

As shown in FIG. 6, for a waveform that ADC should theoretically collect at a certain moment, envelope 1 (a group with relatively high strength), i.e., the reference pulse peak moment t_{ref1}, is acquired, and envelopes 2 (a group with relatively low strength), i.e., the target pulse peak moment tₜₐᵣ and the reference pulse peak moment t_{ref2} in the next cycle, is acquired, and the envelopes are input into the signal processing control unit for distance calculation, and substituted into the following formula to calculate a distance to be measured L:

$$L = \frac{c}{2 {n}_{g}} \cdot \frac{1}{{f}_{r}} \cdot \frac{{t}_{tar} - {t}_{ref 1}}{{t}_{ref 2} - {t}_{ref 1}}$$

where c is the vacuum light speed, n_{g} indicates the air refractive index, and fᵣ indicates the repetition frequency of signal laser light, all of which are known parameters measured in advance.

Each target (channel) is usually, repeatedly sampled by M times (such as 600 times, etc.), thereby obtaining distance values {L⁽¹⁾, L⁽²⁾, . . . L^{(M)}} calculated by M groups of LM fitting results. The accidental noise is eliminated by weighted average, and L̅ is obtained by averaging the remaining values, thereby obtaining a more stable distance value estimation.

Geometric calibration is as follows: standard targets are placed, where multiple standard corner reflectors are placed in different directions in a field of view of the system at positions with known precise coordinates; it is ensured that these calibration points are reasonably distributed to cover all angle/distance sections of the system range. The calibration points are measured, where the echo or interference data of these calibration points are collected by the conventional measurement process of the system to obtain their values in the internal coordinates of the system. The error model is established, where various errors are considered, such as a difference between a scanning angle of the galvanometer and an actual space angle, a beam exit position offset, the inclination of an detector installation angle, and a dual-optical comb beat frequency nonlinearity. A series of parameters to be estimated (such as a scanning scale factor, offset, zero-point drift, etc.) are added when a “system measured value” is mapped to the “real space coordinates” by a mathematical model. The calibration parameters are solved, and on the premise of knowing the “real coordinates” (obtained from a measurement tool of the calibration target) and “system observed value”, an optimal set of system parameters is solved by nonlinear fitting or other methods. The obtained calibration parameters are introduced into the system to re-measure the calibration point and check whether the deviation is within an acceptable range. If the deviation is still large, the parameters are re-calibrated or the error model is improved until the expected accuracy is achieved.

The above parameters are firmed into the software of the measurement system. When measuring any unknown target, a position (x, y, z) of the target object in the real three-dimensional coordinates can be calculated in real time according to the original data such as the galvanometer angle and optical path. Multi-channel and multi-angle data is calibrated and fused to output a 3D point cloud.

The technical features of the above embodiments can be combined at will. To make the description concise, not all possible combinations of the technical features in the above embodiments are described. However, it should be considered that these combinations of technical features fall within the scope recorded in this specification provided that these combinations of technical features do not have any conflict.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A multi-target three-dimensional measurement apparatus based on a dual-optical comb femtosecond lidar, comprising a dual-optical comb laser source, a single-detector time-division switching receiving module, a beam-splitting and optical-switch module and a scanning galvanometer module connected in sequence, as well as a signal control processing module connected to the single-detector time-division switching receiving module, wherein
the dual-optical comb laser source is configured to emit a measurement signal pulse to a reference target in the single-detector time-division switching receiving module and a target optical path in the beam-splitting and optical-switch module, and further configured to emit a sampling signal pulse to a reference optical path and a measurement optical path in the single-detector time-division switching receiving module;
the single-detector time-division switching receiving module is configured to receive an echo pulse from each target optical path according to a timing switching signal, enabling the echo pulse and the sampling signal pulse to undergo sum-frequency generation in the measurement optical path, perform photodetection by a first photodetector to generate a target pulse signal, and input the target pulse signal into Channel 1 of an analog-to-digital converter, wherein the echo pulse is an echo pulse of the measurement signal pulse; and further configured to enable a reflected pulse passing through the reference target and the sampling signal pulse to undergo sum-frequency generation in the reference optical path, perform photodetection by a second photodetector to generate a reference pulse signal, and input the reference pulse signal into Channel 2 of the analog-to-digital converter;
the beam-splitting and optical-switch module is configured to divide the measurement signal pulse into a plurality of pulses to be emitted to the target optical paths, and control on-off of an optical switch on each target optical path according to the timing switching signal to implement time-division multiplexing measurement on a plurality of targets or channels;
the scanning galvanometer module is configured to, in each target optical path, sample a target area to be measured of a target object in a two-dimensional or three-dimensional space using a scanning galvanometer according to a predetermined scanning trajectory; and
the signal control processing module is configured to perform distance calculation according to the reference pulse signal and the target pulse signal of each target optical path to determine a distance to be measured of the target object, and perform three-dimensional reconstruction on the target object according to the distance to be measured of the target object and angle information of the scanning galvanometer to generate a point cloud or three-dimensional contour map of the target object in a current scenario.

2. The multi-target three-dimensional measurement apparatus based on the dual-optical comb femtosecond lidar according to claim 1, wherein the single-detector time-division switching receiving module comprises a measurement signal pulse optical path, and a sampling signal pulse optical path;
wherein the measurement signal pulse optical path comprises a reference target optical path and the reference optical path, and the reference target optical path comprises a first collimator, a first half-wave plate, a first mirror, a first polarizing beam splitter, a quarter-wave plate and a reference target in a same optical path;
the measurement signal pulse is reflected into the reference optical path via the reference target optical path to undergo sum-frequency generation with the sampling signal pulse in the reference optical path, and photodetection is performed by the second photodetector to generate the reference pulse signal;
the sampling signal pulse optical path comprises a reflection optical path and a polarization optical path that share a second collimator, a second half-wave plate and a second polarizing beam splitter; the reflection optical path further comprises a second mirror and the measurement optical path; and the polarization optical path further comprises a third half-wave plate, a third polarizing beam splitter and the reference optical path; and
after the sampling signal pulse is polarized and split by the second polarizing beam splitter, a beam of the sampling signal pulse is reflected by the second mirror to the measurement optical path, and another beam of the sampling signal pulse enters the reference optical path after passing through the third half-wave plate and the third polarizing beam splitter.

3. The multi-target three-dimensional measurement apparatus based on the dual-optical comb femtosecond Lidar according to claim 2, wherein the measurement optical path comprises a first focusing lens, a first sum-frequency crystal, a first low pass filter and the first photodetector in a same optical path;
the reference optical path comprises the second polarizing beam splitter, a second focusing lens, a second sum-frequency crystal, a second low pass filter, and the second photodetector in a same optical path.

4. The multi-target three-dimensional measurement apparatus based on the dual-optical comb femtosecond lidar according to claim 1, wherein the beam-splitting and optical-switch module comprises a beam splitter, and a plurality of target optical paths;
wherein the beam splitter is configured to divide the measurement signal pulse into the plurality of pulses to be emitted to target optical paths; and
each target optical path comprises an optical fiber, a third collimator, an optical switch and the target object in a same optical path, wherein the optical switch is a liquid crystal beam shutter.

5. The multi-target three-dimensional measurement apparatus based on the dual-optical comb femtosecond lidar according to claim 4, wherein the scanning galvanometer module is arranged between the optical switch and the target object, and is configured to change a beam exit angle to scan and measure the target object.

6. The multi-target three-dimensional measurement apparatus based on the dual-optical comb femtosecond lidar according to claim 1, wherein the signal control processing module comprises an FPGA (field programmable gate array) and a GPU (graphics processing unit);
wherein the FPGA is configured to perform distance calculation according to the reference pulse signal and the target pulse signal of each target optical path; and
the GPU is configured to perform distance calculation according to the reference pulse signal and the target pulse signal of each target optical path.

7. A multi-target three-dimensional measurement method based on a dual-optical comb femtosecond lidar, wherein the multi-target three-dimensional measurement method based on the dual-optical comb femtosecond lidar is applied to the multi-target three-dimensional measurement apparatus based on the dual-optical comb femtosecond lidar according to claim 1, and comprises the following steps:
by a dual-optical comb laser, emitting a measurement signal pulse to a reference target in a single-detector time-division switching receiving module and a target optical path in a beam-splitting and optical-switch module, and emitting a sampling signal pulse to a reference optical path and a measurement optical path in the single-detector time-division switching receiving module;
generating a target pulse signal according to an echo pulse of the measured signal pulse returned by the target optical path and the sampling signal pulse on the measurement optical path;
generating a reference pulse signal according to a reflected pulse passing through the reference target and the sampling signal pulse;
performing distance calculation according to the reference pulse signal and the target pulse signal of each target optical path to determine a distance to be measured of a target object; and
reconstructing the target object in three dimensions according to the distance to be measured of the target object and angle information of a scanning galvanometer to generate a point cloud or three-dimensional contour map of the target object in a current scenario.

8. The multi-target three-dimensional measurement method based on the dual-optical comb femtosecond lidar according to claim 7, wherein performing distance calculation according to the reference pulse signal and the target pulse signal of each target optical path to determine the distance to be measured of the target object comprises:
generating continuous sampled data by combining the reference pulse signal and the target pulse signal;
dividing the continuous sampled data into time domain segments of multiple channels based on a timing switching signal;
preprocessing each time domain segment to determine an initial position of a pulse peak;
selecting a Gaussian pulse model for an echo pulse of each channel to establish a least-squares residual function; and
using the initial position of the pulse peak as an initial fitting value based on the least-squares residual function, and fitting the Gaussian pulse model and the continuous sampled data by an LM (Levenberg-Marquardt) fitting algorithm to determine the distance to be measured of the target object.

9. The multi-target three-dimensional measurement method based on the dual-optical comb femtosecond lidar according to claim 8, wherein using the initial position of the pulse peak as the initial fitting value based on the least-squares residual function, and fitting the Gaussian pulse model and the continuous sampled data by the LM fitting algorithm to determine the distance to be measured of the target object comprise:
determining the distance to be measured of the target object by
$$L = \frac{c}{2 {n}_{g}} \cdot \frac{1}{{f}_{r}} \cdot \frac{{t}_{tar} - {t}_{ref 1}}{{t}_{ref 2} - {t}_{ref 1}} ,$$
wherein L is the distance to be measured of the target object, c is a vacuum light speed, n_{g} is an air refractive index, fᵣ is a repetition frequency of signal laser light, tₜₐᵣ is a target pulse peak moment of the target pulse signal, t_{ref1} is a reference pulse peak moment of the reference pulse signal, and t_{ref2} is a reference pulse peak moment of the reference pulse signal in a next cycle.

10. The multi-target three-dimensional measurement method based on the dual-optical comb femtosecond lidar according to claim 7, wherein reconstructing the target object in three dimensions according to the distance to be measured of the target object and the angle information of the scanning galvanometer to generate the point cloud or three-dimensional contour map of the target object in the current scenario comprises:
establishing a corresponding relationship between the distance to be measured of the target object as well as the angle information of the scanning galvanometer and real space coordinates through geometric calibration; and
reconstructing the target object in three dimensions according to the corresponding relationship to generate the point cloud or three-dimensional contour map of the target object in the current scenario.

11. The multi-target three-dimensional measurement method based on the dual-optical comb femtosecond lidar according to claim 7, wherein the single-detector time-division switching receiving module comprises a measurement signal pulse optical path, and a sampling signal pulse optical path;
wherein the measurement signal pulse optical path comprises a reference target optical path and the reference optical path, and the reference target optical path comprises a first collimator, a first half-wave plate, a first mirror, a first polarizing beam splitter, a quarter-wave plate and a reference target in a same optical path;
the measurement signal pulse is reflected into the reference optical path via the reference target optical path to undergo sum-frequency generation with the sampling signal pulse in the reference optical path, and photodetection is performed by the second photodetector to generate the reference pulse signal;
the sampling signal pulse optical path comprises a reflection optical path and a polarization optical path that share a second collimator, a second half-wave plate and a second polarizing beam splitter; the reflection optical path further comprises a second mirror and the measurement optical path; and the polarization optical path further comprises a third half-wave plate, a third polarizing beam splitter and the reference optical path; and
after the sampling signal pulse is polarized and split by the second polarizing beam splitter, a beam of the sampling signal pulse is reflected by the second mirror to the measurement optical path, and another beam of the sampling signal pulse enters the reference optical path after passing through the third half-wave plate and the third polarizing beam splitter.

12. The multi-target three-dimensional measurement method based on the dual-optical comb femtosecond lidar according to claim 11, wherein the measurement optical path comprises a first focusing lens, a first sum-frequency crystal, a first low pass filter and the first photodetector in a same optical path;
the reference optical path comprises the second polarizing beam splitter, a second focusing lens, a second sum-frequency crystal, a second low pass filter, and the second photodetector in a same optical path.

13. The multi-target three-dimensional measurement method based on the dual-optical comb femtosecond lidar according to claim 7, wherein the beam-splitting and optical-switch module comprises a beam splitter, and a plurality of target optical paths;
wherein the beam splitter is configured to divide the measurement signal pulse into the plurality of pulses to be emitted to target optical paths; and
each target optical path comprises an optical fiber, a third collimator, an optical switch and the target object in a same optical path, wherein the optical switch is a liquid crystal beam shutter.

14. The multi-target three-dimensional measurement method based on the dual-optical comb femtosecond lidar according to claim 13, wherein the scanning galvanometer module is arranged between the optical switch and the target object, and is configured to change a beam exit angle to scan and measure the target object.

15. The multi-target three-dimensional measurement method based on the dual-optical comb femtosecond lidar according to claim 7, wherein the signal control processing module comprises an FPGA (field programmable gate array) and a GPU (graphics processing unit);
wherein the FPGA is configured to perform distance calculation according to the reference pulse signal and the target pulse signal of each target optical path; and
the GPU is configured to perform distance calculation according to the reference pulse signal and the target pulse signal of each target optical path.
